(19) United States
(12) Patent Application Publication
(10) Pub. No.: US 2019/0057355 A1
(43) Pub. Date: Feb. 21, 2019

(54) SYSTEMS AND METHODS FOR DETERMINING ACCURACY OF USER-PROVIDED DATA FOR PAGES IN A SOCIAL NETWORKING SYSTEM

(71) Applicant: Facebook, Inc., Menlo Park, CA (US)

(72) Inventors: Suhel Reto Sheikh, Redwood City, CA (US); Yu Tao, London (GB)

(21) Appl. No.: 15/682,252

(22) Filed: Aug. 21, 2017

(51) Int. Cl. G06Q 10/10; G06N 5/02

(52) U.S. Cl. CPC G06Q 10/107; G06N 5/02

(57) ABSTRACT

Systems, methods, and non-transitory computer readable media can identify a set of users that satisfy criteria associated with accuracy of claims, wherein each claim is submitted by a user and indicates a value for information associated with a page of a social networking system. A machine learning model can be trained based on training data including claims submitted by the set of users. One or more claims submitted by users can be evaluated based on the trained machine learning model to determine whether values for information associated with pages in the one or more claims are accurate.

### FIELD OF THE INVENTION

The present technology relates to the field of social networks. More particularly, the present technology relates to techniques for determining accuracy of user-provided data for pages associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, and other types of entities. Pages can be dedicated locations on the social networking system to reflect the presence of the entities on the social networking system.

### SUMMARY

Various embodiments of the present disclosure can include systems, methods, and non-transitory computer readable media configured to identify a set of users that satisfy criteria associated with accuracy of claims, wherein each claim is submitted by a user and indicates a value for information associated with a page of a social networking system. A machine learning model can be trained based on training data including claims submitted by the set of users. One or more claims submitted by users can be evaluated based on the trained machine learning model to determine whether values for information associated with pages in the one or more claims are accurate.

In some embodiments, the identifying the set of users that satisfy criteria associated with accuracy of claims is based on one or more factors.

In certain embodiments, the one or more factors include one or more of: a number of claims submitted by a user, a number of suggestions submitted by a user, accuracy of responses to honeypot questions, or whether a user is a spammer.

In an embodiment, a honeypot question is associated with an expected response that satisfies a threshold confidence value.

In some embodiments, a user is identified as satisfying the criteria associated with accuracy of claims when all of the one or more factors are satisfied.

In certain embodiments, a user is identified as satisfying the criteria associated with accuracy of claims when a weighted combination of the one or more factors is satisfied.

In an embodiment, the identifying the set of users that satisfy criteria associated with accuracy of claims is based on a machine learning model that predicts whether users are likely to be accurate with respect to claims.

In some embodiments, the training the machine learning model is based on features selected from one or more of: user attributes, page attributes, or claim attributes.

In certain embodiments, the trained machine learning model determines a score associated with a value for information associated with a page, wherein the score is indicative of whether the value is accurate.

In an embodiment, values for information associated with pages that are determined to be accurate can be associated with corresponding pages.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example page data accuracy determination module configured to determine accuracy of user provided data for pages, according to an embodiment of the present disclosure.

FIG. 2 illustrates an example page claim processing module configured to process user claims for pages, according to an embodiment of the present disclosure.

FIG. 3A illustrates an example first user interface associated with determining accuracy of user provided data for pages, according to an embodiment of the present disclosure.

FIG. 3B illustrates an example second user interface associated with determining accuracy of user provided data for pages, according to an embodiment of the present disclosure.

FIG. 4 illustrates an example first method for determining accuracy of user provided data for pages, according to an embodiment of the present disclosure.

FIG. 5 illustrates an example second method for determining accuracy of user provided data for pages, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Determining Accuracy of User-Provided Data for Pages in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide user profiles for various users through which users may add connections, such as friends, or publish content items.

The social networking system may provide pages for various entities. For example, pages may be associated with companies, businesses, brands, products, artists, public figures, entertainment, individuals, and other types of entities. Pages can be dedicated locations on the social networking system to reflect a presence of entities on the social networking system. In some cases, information relating to pages can be provided by users. For example, information relating to a page can be obtained based on crowdsourcing from users and associated with a corresponding page. Information relating to a page can include information associated with an entity represented by the page, such as a name, an address, operating hours, etc. However, it can be difficult to determine accuracy of information relating to pages provided by users. For instance, human review may be needed to determine whether information relating to pages provided by users is correct or not. Reviewing such information provided by many users for many pages undesirably can require a significant amount of time and resources.

An improved approach rooted in computer technology can overcome the foregoing and other disadvantages associated with conventional approaches specifically arising in the realm of computer technology. Based on computer technology, the disclosed technology can predict whether information relating to pages provided or submitted by users is accurate based on machine learning techniques. The disclosed technology can identify users who are likely to be accurate and train a machine learning model based on information relating to pages provided by the identified users. In some embodiments, information relating to pages can be obtained from users by presenting questions to users and obtaining responses to the questions from the users. Each response to a question can be referred to as a “claim.” The machine learning model can be trained based on training data that includes claims from users who are likely to be accurate. Users who are likely to be accurate can be identified based on various factors. Examples of factors can include a number of claims submitted by a user, a number of suggestions submitted by a user (e.g., in a time period), accuracy of responses by a user to honeypot questions, and whether a user is a spammer or not. Claims from users determined to be accurate based on the various factors can be considered to be accurate and used as the training data for the machine learning model. The trained machine learning model can be applied to claims from users in order to predict whether the claims or values included in the claims are accurate. In this way, the disclosed technology can predict accuracy associated with claims from users without requiring human review of a large number of claims, which can provide scalability. The disclosed technology can identify users who are likely to be accurate in an automated manner and can provide an efficient way of training the machine learning model. Details relating to the disclosed technology are explained below.

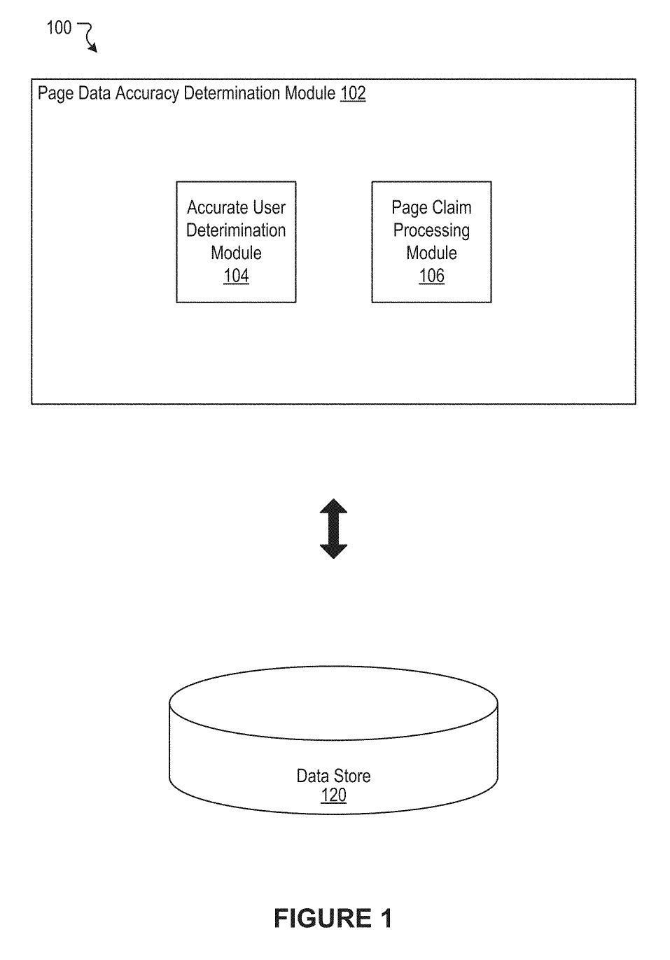

FIG. 1 illustrates an example system 100 including an example page data accuracy determination module 102 configured to determine accuracy of user provided data for pages, according to an embodiment of the present disclosure. The page data accuracy determination module 102 can include an accurate user determination module 104 and a page claim processing module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the page data accuracy determination module 102 can be implemented in any suitable combinations. While the disclosed technology is described in connection with pages of a social networking system for illustrative purposes, the disclosed technology can apply to any other type of system and/or content.

Information relating to a page can include information associated with an entity represented by the page. Information relating to a page can be referred to as “page information.” In some embodiments, page information can include one or more fields. For example, one or more fields of page information can include a name, an address, a category, operating hours, etc. In some cases, page information can be obtained based on crowdsourcing from users of a social networking system. Users can provide page information for one or more pages. For example, users can provide values for one or more fields of page information. In some embodiments, users can provide page information in response to questions relating to pages that are presented to the users. A question relating to a page can be associated with a field of page information. For example, a question relating to a page can include a value for a field of page information and ask a user to indicate whether the value is correct or not. For instance, a question can ask whether the address of an entity represented by a page is a specific address. The value for a field of page information included in a question may be a value that has been previously provided by users or obtained from other sources. As another example, a question relating to a page can ask a user to provide a value for a field of page information. For instance, a question can ask what the address of an entity represented by a page is.

A response by a user to a question relating to a page can be referred to as a “claim.” A claim can indicate whether a particular value for a field of page information is correct, or can provide a particular value for a field of page information. Accordingly, each claim can be associated with a particular value for a field of page information. Values for fields of page information in claims can be associated with corresponding pages if the values satisfy a certain confidence level. If a value for a field of page information in a claim is associated with a page, the claim can be considered to be accepted. Questions relating to pages can be presented to users in various user interfaces associated with a social networking system at various times. For example, questions relating to pages can be presented to users when users check in to pages. As another example, questions relating to pages can be presented to users when previous claims by users are accepted. In certain embodiments, users can provide values for fields of page information without being presented questions relating to pages. In these embodiments, values for fields of page information provided by users can also be referred to as claims.

The accurate user determination module 104 can determine a set of user who are likely to be accurate with respect to claims. Users who are likely to be accurate or reliable with respect to claims can be referred to as “accurate users.” Users who are not accurate users can be referred to as “inaccurate users.” Accurate users can be identified in various ways. In some embodiments, the accurate user determination module 104 can determine accurate users based on various factors. The factors can relate to determining whether users are likely to provide accurate information, and can be selected as appropriate. In some embodiments, a user can be determined to be accurate if the user satisfies all factors. In these embodiments, if the user does not satisfy any factor, the user is determined to be inaccurate. In other embodiments, factors can be weighted, for example, based on importance, and a user can be determined to be accurate if the user satisfies a weighted combination of factors.

In some embodiments, factors can include a number of claims submitted or provided by a user, a number of suggestions submitted or provided by a user (e.g., in a time period), accuracy of responses by a user to honeypot questions, and whether a user is a spammer. A number of claims submitted by a user can be a total number of claims submitted by a user, for example, to date. For example, the number of claims can indicate a number of claims submitted by a particular user since the user joined the social networking system. In certain embodiments, the number of claims can be associated with a time period (e.g., day(s), month(s), year(s)). In some cases, users who submit more claims are more likely to be accurate than users who submit fewer claims. The number of claims factor can be satisfied if the number of claims submitted by the user satisfies a threshold value.

A number of suggestions submitted by a user can indicate a total number of suggestions submitted by the user. A suggestion can refer to an edit to page information that is associated with a page. For example, a suggestion can be submitted by a user via a user interface displaying a page on a computing device of the user. In certain embodiments, the number of suggestions can be associated with a time period (e.g., day(s), month(s), year(s)). In some cases, users who have submitted suggestions are more likely to be accurate than users who have not submitted suggestions. For example, users who have submitted suggestions recently are more likely to be accurate than users who have not submitted suggestions recently or who have not submitted any suggestions. The number of suggestions factor can be satisfied if the number of suggestions submitted by the user (e.g., in a time period) satisfies a threshold value.

Accuracy of responses by a user to honeypot questions can indicate a ratio or a percentage of accurate responses to honeypot questions presented to the user. A honeypot question can appear to be similar to a question relating to pages presented to users, but include false or unrelated information. Since a honeypot question includes false or unrelated information, an expected response by a user to the honeypot question can be negative (e.g., “no,” “disagree,” etc.). As an example, Company A is a software company, and a honeypot question relating to the company can ask if Company A is a beverage company. In this example, the expected response by a user to the honeypot question would be negative. A honeypot question that includes false or unrelated information may be referred to as a negative honeypot question. In some embodiments, a honeypot question can include true or related information, and an expected response to the honeypot question can be positive or affirmative (e.g., “yes,” “agree,” etc.). A honeypot question that includes true or related information may be referred to as a positive honeypot question. A honeypot question can be formulated such that an expected response to the honeypot question satisfies a threshold confidence level. Accuracy of responses to honeypot questions can help distinguish between accurate users and inaccurate users. The factor of accuracy of responses to honeypot questions can be satisfied if accuracy of responses by a user to honeypot questions satisfies a threshold value.

The factor of whether a user is a spammer can attempt to identify a person, a bot, or another entity that may be spamming or may not be interested in providing accurate information. A user that is likely to be a spammer tends to respond to all questions in the same way. For example, a user that is likely to be a spammer may answer positively for all questions or negatively for all questions. Accordingly, in some embodiments, whether a user is a spammer can be determined based on whether the user answered the same way to all questions, for example, positively to all questions or negatively to all questions. In these embodiments, the factor of whether a user is a spammer can be satisfied if the user answers all questions positively or the user answers all questions negatively. In other embodiments, whether a user is a spammer can be determined based on a ratio of positive responses to negative responses or a ratio of negative responses to positive responses. In these embodiments, the factor of whether a user is a spammer can be satisfied if the ratio of positive responses to negative responses or the ratio of negative responses to positive responses satisfies a threshold value.

In certain embodiments, the accurate user determination module 104 can determine accurate users based on machine learning techniques. For example, a machine learning model can be trained to predict whether a particular user is likely to be accurate with respect to claims. For example, the machine learning model can be trained based on training data that includes information relating to users who have been determined to be accurate with respect to claims. Various information can be used to train the machine learning model. For example, such information can include features relating to users and claims and labels relating to accuracy. All examples herein are provided for illustrative purposes, and there can be many variations and other possibilities.

The page claim processing module 106 can process user claims for pages. For example, the page claim processing module 106 can predict whether claims or values in claims are likely to be accurate based on a machine learning model. Values for fields of page information that are determined to be accurate can be associated with corresponding pages. Functionality of the page claim processing module 106 is described in more detail herein.

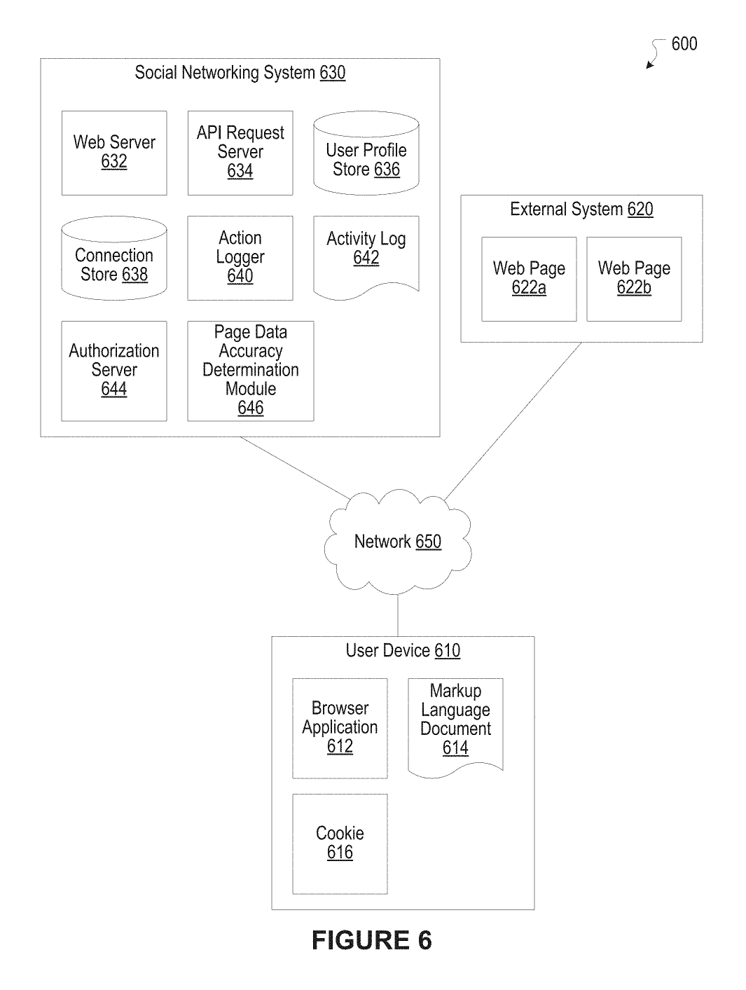

In some embodiments, the page data accuracy determination module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the page data accuracy determination module 102 can be, in part or in whole, implemented as software running on one or more computing devices or systems, such as on a server system or a client computing device. In some instances, the page data accuracy determination module 102 can be, in part or in whole, implemented within or configured to operate in conjunction or be integrated with a social networking system (or service), such as a social networking system 630 of FIG. 6. Likewise, in some instances, the page data accuracy determination module 102 can be, in part or in whole, implemented within or configured to operate in conjunction or be integrated with a client computing device, such as the user device 610 of FIG. 6. For example, the page data accuracy determination module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the page data accuracy determination module 102. The data maintained by the data store 120 can include, for example, information relating to pages, page information, fields of page information, accurate or inaccurate users, factors for determining accurate users, claims, suggestions, honeypot questions, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the page data accuracy determination module 102 can be configured to communicate and/or operate with the data store 120. In some embodiments, the data store 120 can be a data store within a client computing device. In some embodiments, the data store 120 can be a data store of a server system in communication with the client computing device.

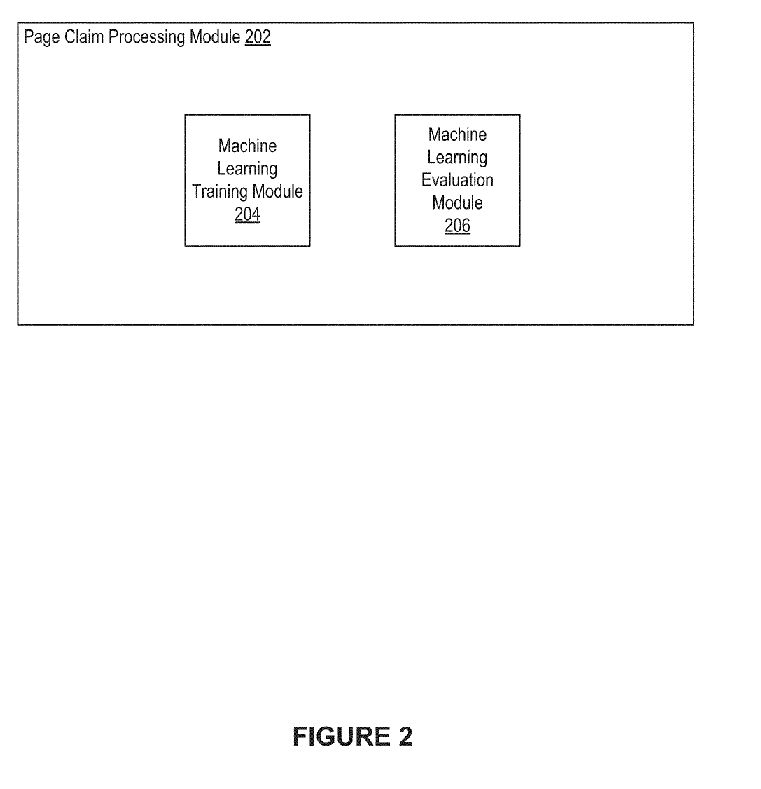

FIG. 2 illustrates an example page claim processing module 202 configured to process user claims for pages, according to an embodiment of the present disclosure. In some embodiments, the page claim processing module 106 of FIG. 1 can be implemented with the example page claim processing module 202. As shown in the example of FIG. 2, the example page claim processing module 202 can include a machine learning training module 204 and a machine learning evaluation module 206.

The machine learning training module 204 can train a machine learning model to predict whether a claim or a value associated with a claim is accurate. The machine learning training module 204 can train the machine learning model based on training data that includes claims from accurate users, for example, identified by the accurate user determination module 104. Claims or values in claims from accurate users can be considered to be accurate, for example, for purposes of training the machine learning model. The claims from accurate users in the training data can be indicated or labeled to be accurate. Various features can be used in training the machine learning model. For example, features can be selected from user attributes, page attributes, claim attributes, etc. User attributes can include any attributes associated with users. Examples of user attributes can include a location (e.g., a country, state, county, city, etc.), an age, an age range, a gender, device information (e.g., mobile or desktop, operating system, etc.), whether a user checked in to a page, whether a user liked a page, whether a user is from a similar or same geographical location and/or region as a page, how many claims from a user are accurate, a ratio of claims from a user that are accurate or inaccurate, how long a user has been a user of a social networking system, etc. Checking in to a page can indicate that a user has visited an entity or a location represented by the page. A user can check in to a page by accessing the page and selecting a menu item or an icon. Page attributes can include any attributes associated with pages. Examples of page attributes can include a page category, whether a page is claimed by an entity represented by the page (e.g., owned or unowned), a location (e.g., a country, state, county, city, etc.), a number of connections of a page, popularity of a page, etc. Claim attributes can include any attributes associated with claims. Examples of claim attributes can include a user associated with a claim, a page associated with a claim, a question associated with a claim, a field of page information to which a claim relates, a value for a field of page information to which a claim relates, whether a user indicated a value for a field of page information is correct, how many users indicated a value for a field of page information as correct or incorrect, a ratio of users who indicated a value for a field of page information as correct or incorrect, how many claims have the same value for a field of page information to which a claim relates, a ratio of claims that have the same value for a field of page information, etc. In some embodiments, page information can be obtained based on computer technology or from other sources. For example, a system can suggest that an entity is a restaurant based on parsing the name of the entity. In these embodiments, features for training the machine learning model can also relate to such page information. For example, a feature can indicate whether a value for a field of page information agrees with a value for the field obtained based on computer technology or other sources. Weights associated with various features used to train the machine learning model can be determined. The machine learning model can be retrained based on new or updated training data. For example, if information about new users, new pages, and/or new claims becomes available, the machine learning training module 204 can train the machine learning model based on the information about new users, new pages, and/or new claims. In certain embodiments, more than one machine learning model or a staged machine learning model can be used.

The machine learning evaluation module 206 can apply the trained machine learning model to claims in order predict whether a claim or a value associated with a claim is accurate. For example, the trained machine learning model can determine a score for a value provided in one or more claims for a field of page information. The score can be indicative of how likely the value for the field of page information is accurate. For instance, unique values for a field of page information can be obtained from one or more claims, and the trained machine learning model can determine a score for each unique value for the field of page information. A value for a field can be determined to be accurate if a score for the value satisfies a threshold confidence value. The threshold confidence value can be selected to provide a certain level of confidence or accuracy. If a value for a field of page information satisfies the threshold confidence value, the value for the field of page information can be associated with the field of page information and therefore associated with the page. If there are multiple values for a field of page information that satisfy the threshold confidence value, a value of the multiple values having the highest score can be associated with the field of page information. If a value for a field of page information does not satisfy the threshold confidence value, the value for the field of page information is not associated with the field of page information and the page, and additional claims can be obtained from users. In some embodiments, the trained machine learning model can determine a score for each claim, instead of each unique value for a field of page information from various claims, and the score can be indicative of how likely the claim is accurate. In certain embodiments, there may be duplicate or multiple pages for an entity. For example, there can be an official page for an entity, and there can be another page for the entity created from a check in by a user, for example, due to a slight variation in the spelling of the entity's name. In these embodiments, if the duplicate pages are determined to be related to the same entity, claims from the duplicates pages can be used in determining page information for the entity. All examples herein are provided for illustrative purposes, and there can be many variations and other possibilities.

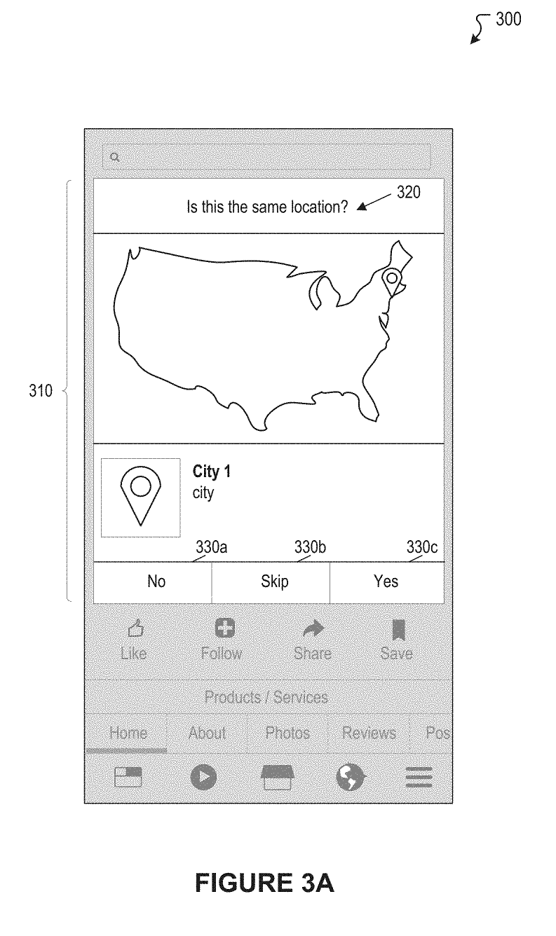

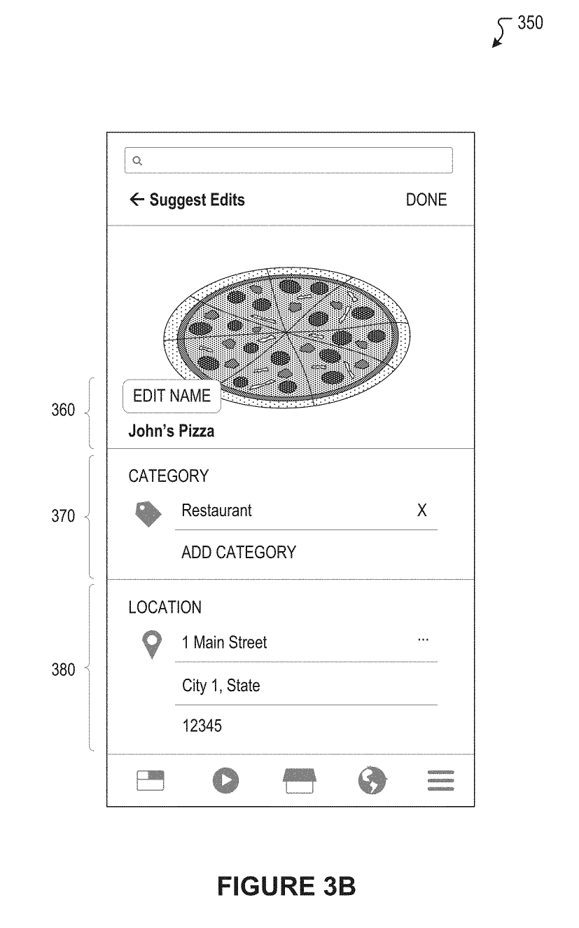

FIG. 3A illustrates an example first user interface 300 associated with determining accuracy of user provided data for pages, according to an embodiment of the present disclosure. The user interface 300 illustrates a pane 310 for presenting a question relating to a page. The pane 310 can include a question 320 and one or more response options 330. In the example of FIG. 3A, the question 320 asks whether a city shown on the map is the same location as City 1. The question can relate to a field of page information relating to a page. In this example, the question can relate to a field for a location of an entity represented by the page. A user can select one of the response options 330 in response to the question 320. A response option 330a indicates a positive response (e.g., “Yes”) to the question 320. A response option 330b indicates an option for skipping the question 320. A response option 330c indicates a negative response (e.g., “No”) to the question 320. If a user selects the response option 330a or the response option 330c, the corresponding response can be a claim for the location field for the page. Claims from users who are determined to be accurate can be used as training data for training a machine learning model, as described above in connection with the page data accuracy determination module 102. Claims from users other than users who are determined to be accurate can be evaluated based on the training machine learning model.

FIG. 3B illustrates an example second user interface 350 associated with determining accuracy of user provided data for pages, according to an embodiment of the present disclosure. The user interface 350 illustrates an example user interface in which a user can provide one or more suggestions for a page. The user interface 350 includes a section 360 for editing a name of the page. The user interface 350 also includes a section 370 for editing a category of the page. For example, a user can enter or select a new category or delete an existing category for the page. The user interface 350 further includes a section 380 for editing a location for the page. For example, a user can edit the location by entering an address. The number of suggestions submitted by a user can be a factor for determining accurate users, as described above in connection with the page data accuracy determination module 102.

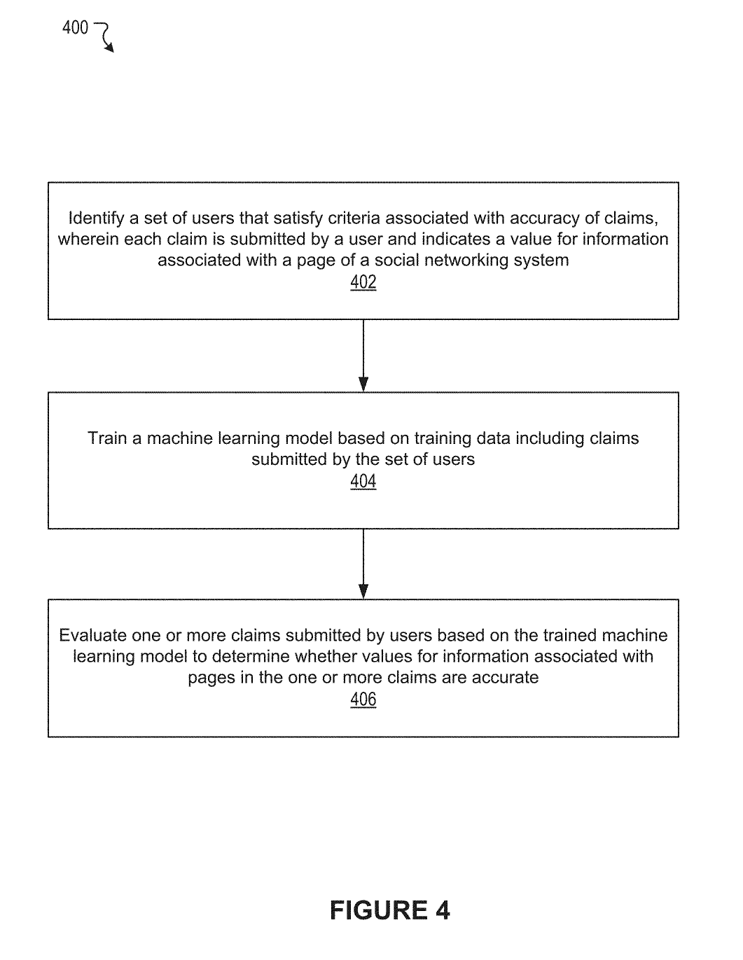

FIG. 4 illustrates an example first method 400 for determining accuracy of user provided data for pages, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can identify a set of users that satisfy criteria associated with accuracy of claims, wherein each claim is submitted by a user and indicates a value for information associated with a page of a social networking system. At block 404, the example method 400 can train a machine learning model based on training data including claims submitted by the set of users. At block 406, the example method 400 can evaluate one or more claims submitted by users based on the trained machine learning model to determine whether values for information associated with pages in the one or more claims are accurate. Other suitable techniques that incorporate various features and embodiments of the present disclosure are possible.

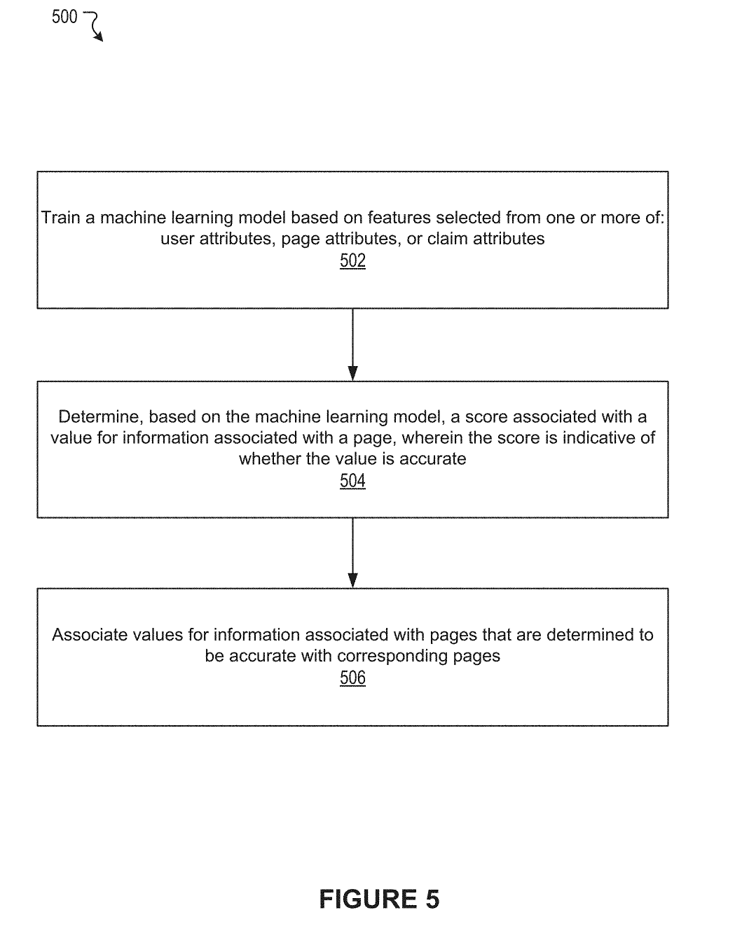

FIG. 5 illustrates an example second method 500 for determining accuracy of user provided data for pages, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can train a machine learning model based on features selected from one or more of: user attributes, page attributes, or claim attributes. The machine learning model can be similar to the machine learning model explained in connection with FIG. 4. At block 504, the example method 500 can determine, based on the machine learning model, a score associated with a value for information associated with a page, wherein the score is indicative of whether the value is accurate. At block 506, the example method 500 can associate values for information associated with pages that are determined to be accurate with corresponding pages. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an page data accuracy determination module 646. The page data accuracy determination module 646 can be implemented with the page data accuracy determination module 102, as discussed in more detail herein. In some embodiments, one or more functionalities of the page data accuracy determination module 646 can be implemented in the user device 610.

### Hardware Implementation

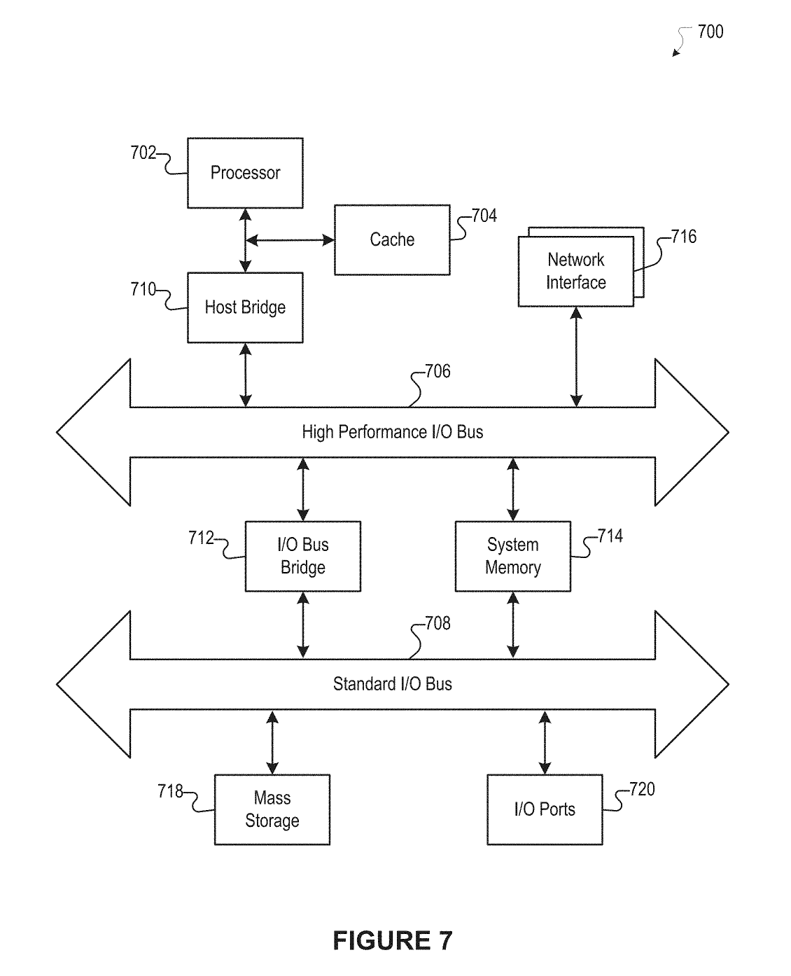

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the ×86-compatible processors manufactured by Intel Corporation of Santa Clara, Calif., and the ×86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
identifying, by a computing system, a set of users that satisfy criteria associated with accuracy of claims, wherein each claim is submitted by a user and indicates a value for information associated with an entity represented in a social networking system;
training, by the computing system, a machine learning model based on training data including claims submitted by the set of users; and
evaluating, by the computing system, one or more claims submitted by users based on the trained machine learning model to determine whether values for information associated with entities in the one or more claims are accurate.

2. The computer-implemented method of claim 1, wherein the identifying the set of users that satisfy criteria associated with accuracy of claims is based on one or more factors.

3. The computer-implemented method of claim 2, wherein the one or more factors include one or more of: a number of claims submitted by a user, a number of suggestions submitted by a user, accuracy of responses to honeypot questions, or whether a user is a spammer.

4. The computer-implemented method of claim 3, wherein a honeypot question is associated with an expected response that satisfies a threshold confidence value.

5. The computer-implemented method of claim 3, wherein a user is identified as satisfying the criteria associated with accuracy of claims when all of the one or more factors are satisfied.

6. The computer-implemented method of claim 3, wherein a user is identified as satisfying the criteria associated with accuracy of claims when a weighted combination of the one or more factors is satisfied.

7. The computer-implemented method of claim 1, wherein the identifying the set of users that satisfy criteria associated with accuracy of claims is based on a machine learning model that predicts whether users are likely to be accurate with respect to claims.

8. The computer-implemented method of claim 1, wherein the training the machine learning model is based on features selected from one or more of: user attributes, page attributes, or claim attributes.

9. The computer-implemented method of claim 1, wherein the trained machine learning model determines a score associated with a value for information associated with an entity, wherein the score is indicative of whether the value is accurate.

10. The computer-implemented method of claim 1, further comprising associating values for information associated with entities that are determined to be accurate with corresponding entities.

11. A system comprising:
at least one hardware processor; and
a memory storing instructions that, when executed by the at least one processor, cause the system to perform:
identifying a set of users that satisfy criteria associated with accuracy of claims, wherein each claim is submitted by a user and indicates a value for information associated with an entity represented in a social networking system;
training a machine learning model based on training data including claims submitted by the set of users; and
evaluating one or more claims submitted by users based on the trained machine learning model to determine whether values for information associated with entities in the one or more claims are accurate.

12. The system of claim 11, wherein the identifying the set of users that satisfy criteria associated with accuracy of claims is based on one or more factors.

13. The system of claim 12, wherein the one or more factors include one or more of: a number of claims submitted by a user, a number of suggestions submitted by a user, accuracy of responses to honeypot questions, or whether a user is a spammer.

14. The system of claim 11, wherein the trained machine learning model determines a score associated with a value for information associated with an entity, wherein the score is indicative of whether the value is accurate.

15. The system of claim 11, wherein the instructions further cause the system to perform associating values for information associated with entities that are determined to be accurate with corresponding entities.

16. A non-transitory computer readable medium including instructions that, when executed by at least one hardware processor of a computing system, cause the computing system to perform a method comprising:
identifying a set of users that satisfy criteria associated with accuracy of claims, wherein each claim is submitted by a user and indicates a value for information associated with an entity represented in a social networking system;
training a machine learning model based on training data including claims submitted by the set of users; and
evaluating one or more claims submitted by users based on the trained machine learning model to determine whether values for information associated with entities in the one or more claims are accurate.

17. The non-transitory computer readable medium of claim 16, wherein the identifying the set of users that satisfy criteria associated with accuracy of claims is based on one or more factors.

18. The non-transitory computer readable medium of claim 17, wherein the one or more factors include one or more of: a number of claims submitted by a user, a number of suggestions submitted by a user, accuracy of responses to honeypot questions, or whether a user is a spammer.

19. The non-transitory computer readable medium of claim 16, wherein the trained machine learning model determines a score associated with a value for information associated with an entity, wherein the score is indicative of whether the value is accurate.

20. The non-transitory computer readable medium of claim 16, wherein the method further comprises associating values for information associated with entities that are determined to be accurate with corresponding entities.
